(19) United States
(12) Patent Application Publication
(10) Pub. No.: US 2025/0200722 A1
(43) Pub. Date: Jun. 19, 2025

(54) METHOD AND DEVICE WITH IMAGE ENHANCEMENT

(71) Applicants: Samsung Electronics Co., Ltd., Suwon-si (KR); Seoul National University R&DB Foundation, Seoul (KR)

(72) Inventors: Kinam KWON, Suwon-si (KR); Kyoung Mu LEE, Seoul (KR); Woo Seok LEE, Seoul (KR); Hyong Euk LEE, Suwon-si (KR)

(73) Assignees: Samsung Electronics Co., Ltd., Suwon-si (KR); Seoul National University R&DB Foundation, Seoul (KR)

(21) Appl. No.: 18/979,112

(22) Filed: Dec. 12, 2024

(30) Foreign Application Priority Data
Dec. 15, 2023 (KR) 10-2023-0183426

(51) Int. Cl. G06T 5/60; G06T 5/77; G06T 7/11

(52) U.S. Cl. CPC G06T 5/60; G06T 5/77; G06T 7/11; G06T 2207/20084

(57) ABSTRACT

A processor-implemented method with image enhancement includes, based on an input image, region information about a local region of the input image, and style information about a target style to be applied to the local region, generating a local feature representation, generating a global feature representation based on the input image, based on the local feature representation, the global feature representation, and the region information, determining an adjustment parameter set, and, based on the adjustment parameter set, generating a retouch result by adjusting the input image.

### CROSS-REFERENCE TO RELATED APPLICATIONS

This application claims the benefit under 35 USC § 119(a) of Korean Patent Application No. 10-2023-0183426, filed on Dec. 15, 2023 in the Korean Intellectual Property Office, the entire disclosure of which is incorporated by reference herein for all purposes.

### BACKGROUND

### 1. Field

The following description relates to a method and device with image enhancement.

### 2. Description of Related Art

Image enhancement may correspond to a task of enhancing an original image to suit a purpose. Image restoration may correspond to a task of restoring an image of degraded quality to an image of improved quality. The image enhancement and image restoration may be performed by using a deep learning-based neural network. The neural network may be trained based on deep learning and may perform inference for a desired purpose by mapping input data and output data that are in a nonlinear relationship with each other. Such a trained capability of generating the mapping may be referred to as a learning ability of the neural network. The neural network trained for a special purpose, such as image restoration, may have a generalization ability to generate a relatively accurate output in response to an input pattern that is not yet trained.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with image enhancement includes: based on an input image, region information about a local region of the input image, and style information about a target style to be applied to the local region, generating a local feature representation; generating a global feature representation based on the input image; based on the local feature representation, the global feature representation, and the region information, determining an adjustment parameter set; and based on the adjustment parameter set, generating a retouch result by adjusting the input image.

The local feature representation may be generated by inputting the input image, the region information, and the style information into a neural local encoder, and the global feature representation may be generated by inputting the input image into a neural global encoder.

The adjustment parameter set may be generated by inputting the local feature representation, the global feature representation, and the region information into a neural harmonic decoder.

The neural harmonic decoder may be configured to, based on harmony between the local feature representation and the global feature representation, determine the adjustment parameter set.

The region information may include first region information about a first local region and second region information about a second local region, and the style information may include first style information to be applied to the first local region and second style information to be applied to the second local region.

The generating of the local feature representation may include, based on the input image, the first region information, the second region information, the first style information, and the second style information, generating a first local feature representation corresponding to the first region information and the first style information and a second local feature representation corresponding to the second region information and the second style information.

The determining of the adjustment parameter set may include, based on the first local feature representation, the second local feature representation, the global feature representation, the first region information, and the second region information, determining the adjustment parameter set.

The method may include, based on semantic segmentation, determining the local region from the input image.

The method may include, based on the input image, generating a region mask corresponding to the region information.

The style information may include either one or both of a target style image of the target style and a target style vector of the target style.

In one or more general aspects, a non-transitory computer-readable storage medium may store instructions that, when executed by one or more processors, configure the one or more processors to perform any one, any combination, or all of operations and/or methods described herein.

In one or more general aspects, an electronic device includes: one or more processors configured to: based on an input image, region information about a local region of the input image, and style information about a target style to be applied to the local region, generate a local feature representation; based on the input image, generate a global feature representation; based on the local feature representation, the global feature representation, and the region information, determine an adjustment parameter set; and based on the adjustment parameter set, generate a retouch result by adjusting the input image.

The local feature representation may be generated by inputting the input image, the region information, and the style information into a neural local encoder, and the global feature representation may be generated by inputting the input image into a neural global encoder.

The adjustment parameter set may be generated by inputting the local feature representation, the global feature representation, and the region information into a neural harmonic decoder.

The neural harmonic decoder may be configured to, based on harmony between the local feature representation and the global feature representation, determine the adjustment parameter set.

The region information may include first region information about a first local region and second region information about a second local region, and the style information may include first style information to be applied to the first local region and second style information to be applied to the second local region.

For the generating of the local feature representation, the one or more processors may be configured to, based on the input image, the first region information, the second region information, the first style information, and the second style information, generate a first local feature representation corresponding to the first region information and the first style information and a second local feature representation corresponding to the second region information and the second style information.

For the determining of the adjustment parameter set, the one or more processors may be configured to, based on the first local feature representation, the second local feature representation, the global feature representation, the first region information, and the second region information, determine the adjustment parameter set.

The one or more processors may be configured to, based on the input image, generate a region mask corresponding to the region information.

The style information may include either one or both of a target style image of the target style and a target style vector of the target style.

Other features and aspects will be apparent from the following detailed description, the drawings, and the claims.

### BRIEF DESCRIPTION OF THE DRAWINGS

FIG. 1 illustrates an example of a configuration and operation of a retouch model.

FIG. 2 illustrates an example of a configuration and operation of an adjustment parameter generation model.

FIGS. 3 and 4 illustrate examples of a process of generating region information.

FIG. 5 illustrates an example of an operation of a multi-region-based adjustment parameter generation model.

FIG. 6 illustrates an example of an operation of an image adjustment model.

FIG. 7 illustrates an example of a process of training an adjustment parameter generation model and/or an image adjustment model.

FIG. 8 illustrates an example of an image enhancement method.

FIG. 9 illustrates an example of a configuration of an electronic device.

Throughout the drawings and the detailed description, unless otherwise described or provided, it may be understood that the same drawing reference numerals may refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, the examples will be described in detail with reference to the accompanying drawings. When describing the examples with reference to the accompanying drawings, like reference numerals refer to like elements and a repeated description related thereto will be omitted.

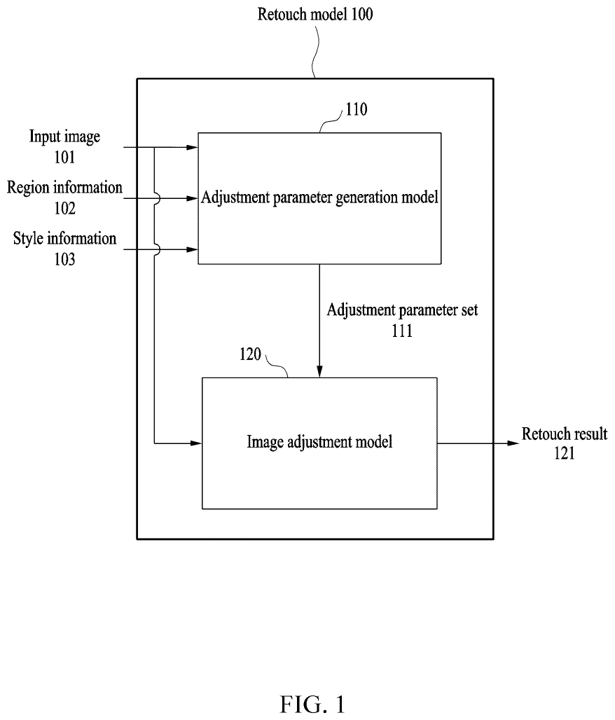

FIG. 1 illustrates an example of a configuration and operation of a retouch model. Referring to FIG. 1, a retouch model 100 may generate, based on an input image 101, region information 102 about a local region of the input image 101, and style information 103 about a target style to be applied to the local region, a retouch result 121 for the input image 101. Image retouch may include image enhancement and/or image restoration. Image enhancement may correspond to a task of enhancing an original image (e.g., brightening an image) to suit a purpose. Image restoration may correspond to a task of restoring an image of degraded quality to an image of improved quality. For example, image retouch may correspond to a retouch task performed by an image expert. The retouch model 100 may learn the retouch task performed by the image expert in advance and may generate the retouch result 121 for the input image 101 by imitating the retouch task performed by the image expert.

The retouch model 100 may include an adjustment parameter generation model 110 and an image adjustment model 120. The adjustment parameter generation model 110 may generate, based on the input image 101, the region information 102, and the style information 103, an adjustment parameter set 111 of the input image 101. The image adjustment model 120 may generate, based on the adjustment parameter set 111, the retouch result 121 for the input image 101 by adjusting the input image 101. The adjustment parameter set 111 may include adjustment parameters for each pixel of the input image 101. The image adjustment model 120 may adjust pixel values of the input image 101 based on the adjustment parameter set 111. The adjustment parameter generation model 110 and/or the image adjustment model 120 may include a neural network.

The neural network may be trained based on deep learning and perform inference suitable for a training purpose by mapping input data and output data that are in a nonlinear relationship with each other. When the adjustment parameter generation model 110 and the image adjustment model 120 each include a neural network, the adjustment parameter generation model 110 and the image adjustment model 120 may be trained to generate the adjustment parameter set 111 and/or the retouch result 121 close to a target retouch image provided as ground truth (GT).

The adjustment parameter generation model 110 may be implemented to include a neural network. The image adjustment model 120 may be implemented to include an image signal processing (ISP) pipeline. The ISP pipeline may be set in advance based on the adjustment parameter set 111 to adjust at least some of digital gain, white balance, color correction, gamma correction, tone mapping, denoising, and deblurring. At least a portion of the ISP pipeline may include a hardware module and/or a software module.

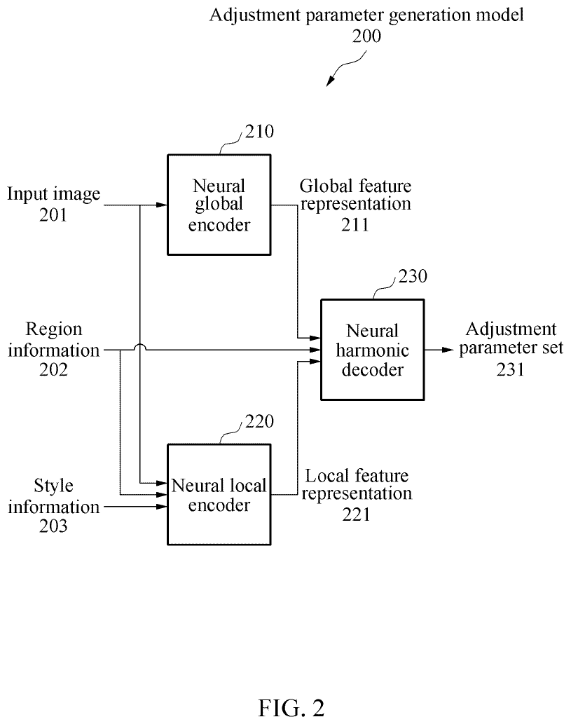

FIG. 2 illustrates an example of a configuration and operation of an adjustment parameter generation model. Referring to FIG. 2, an adjustment parameter generation model 200 (e.g., the adjustment parameter generation model 110 of FIG. 1) may include a neural global encoder 210, a neural local encoder 220, and a neural harmonic decoder 230. The neural global encoder 210, the neural local encoder 220, and the neural harmonic decoder 230 may be implemented based on a neural network. For example, the neural global encoder 210, the neural local encoder 220, and the neural harmonic decoder 230 may have an encoder-decoder structure. For example, the neural global encoder 210 and/or the neural local encoder 220 may correspond to a convolutional neural network or a transformer encoder. The neural harmonic decoder 230 may correspond to a transformer decoder.

The neural global encoder 210 may generate a global feature representation 211 based on an input image 201. The neural local encoder 220 may, based on the input image 201, region information 202 about a local region of the input image 201, and style information 203 about a target style to be applied to the local region, generate a local feature representation 221. The global feature representation 211 may be generated by inputting the input image 201 into the neural global encoder 210. The local feature representation 221 may be generated by inputting the input image 201, the region information 202, and the style information 203 into the neural local encoder 220.

The local region may be separated and determined based on object regions in the input image 201. For example, the object regions may be separated based on semantic segmentation. For example, when the input image 201 is a photo centered around a predetermined subject (e.g., a portrait centered around a person), the object regions may be separated into a main object region (e.g., a person region) and a background region. In this example, the main object region may be set as the local region and the target style may be applied to the object region.

The region information 202 may correspond to a region mask. For example, the region mask may have different values in the local region and another region. For example, the region mask may have a value of 1 in the local region and may have a value of 0 in another region. The region mask may perform a region filtering function. The region mask for identifying the local region based on the input image 201 may be generated. The region mask may be used as the region information 202. The region information 202 may be generated in various ways. For example, the region information 202 may be generated by a separate region segmentation module that is distinct from the adjustment parameter generation model 200, may be generated by a region segmentation module included in the adjustment parameter generation model 200, and/or may be generated by the neural local encoder 220.

The style information 203 may include a target style image of a target style and/or a target style vector of the target style. The target style vector may be a vector corresponding to an arbitrary image to which the target style is applied. For example, the target style vector may be generated by vector encoding based on the target style image. The vector encoding may be performed by a vector encoding model based on a neural network. For example, when the style information 203 includes the target style image, the target style vector corresponding to the target style image may be generated by the vector encoding model. The target style vector may be input into the neural local encoder 220. The vector encoding model may be included in the neural local encoder 220.

The neural harmonic decoder 230 may, based on the local feature representation 221, the global feature representation 211, and the region information 202, generate an adjustment parameter set 231. The adjustment parameter set 231 may be generated by inputting the local feature representation 221, the global feature representation 211, and the region information 202 into the neural harmonic decoder 230.

The neural harmonic decoder 230 may determine the adjustment parameter set 231 based on a harmony between the local feature representation 221 and the global feature representation 211. When a typical decoder uses only a local feature representation for performing retouching without using a global feature representation, the local feature representation may only have a local impact on a local region of region information. In this example, a retouch result may not harmoniously represent the local region and another region. For example, when multiple local regions exist, there may be a lack of harmony between these local regions.

In contrast to the typical decoder, as the neural harmonic decoder 230 of one or more embodiments uses both the global feature representation 211 and the local feature representation 221, the retouch result may harmoniously represent the local region and another region. As described in an example in detail below, a target retouch image having the target style across its entirety may be used as GT for training. The neural global encoder 210, the neural local encoder 220, and the neural harmonic decoder 230 may be trained based on the global feature representation 211 generated by the neural global encoder 210 without information about the target style. According to this training approach, the neural harmonic decoder 230 may generate the adjustment parameter set 231 for applying the target style to the local region and harmoniously representing the local region and another region.

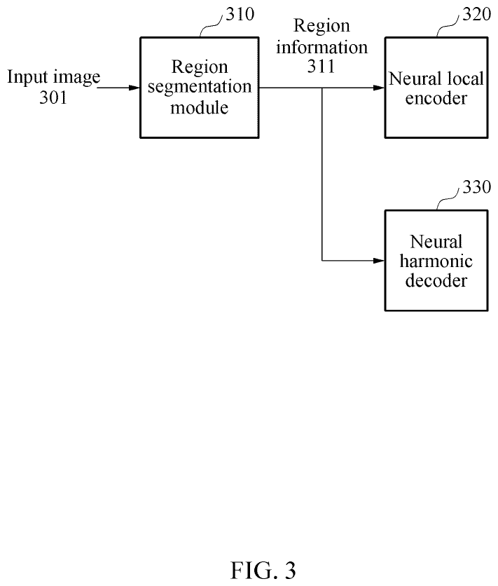

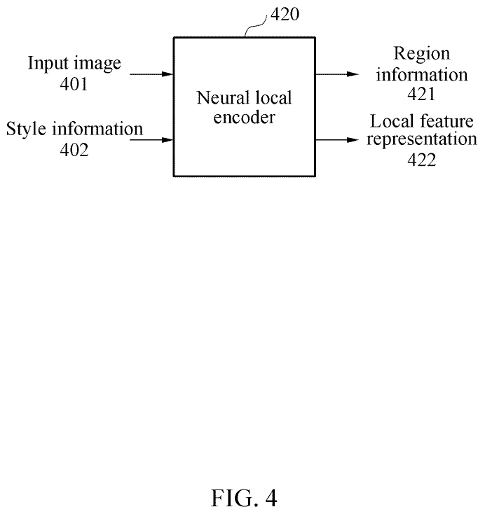

FIGS. 3 and 4 illustrate examples of a process of generating region information. Referring to FIG. 3, a region segmentation module 310 may generate region information 311 based on an input image 301. The region segmentation module 310 may be a module separate from an adjustment parameter generation model (e.g., the adjustment parameter generation model 200 of FIG. 2) or a module included in the adjustment parameter generation model. The region information 311 may be provided to a neural local encoder 320 (e.g., the neural local encoder 220 of FIG. 2) and a neural harmonic decoder 330 (e.g., the neural harmonic decoder 230 of FIG. 2).

The region segmentation module 310 may separate the input image 301 into object regions by performing semantic segmentation on the input image 301, determine a local region to which a target style is applied among the object regions, and generate the region information 311 about the local region. For example, the region segmentation module 310 may include a neural network and perform semantic segmentation based on deep learning. The region segmentation module 310 may determine the local region among the object regions according to a user input or itself determine the local region among the object regions based on its ability developed through previous training. For example, the user input and/or the ability developed through previous training may determine, as the local region, a main object region including a main object among the object regions. The region information 311 may correspond to a region mask.

Referring to FIG. 4, a neural local encoder 420 may generate region information 421 of an input image 401. The neural local encoder 420 of FIG. 4 may be trained to generate region information 421 and a local feature representation 422, based on the input image 401 and style information 402. The neural local encoder 420 may separate the input image 401 into object regions by performing semantic segmentation on the input image 401, determine a local region to which a target style is applied among the object regions, and generate the region information 421 about the local region. The neural local encoder 420 may determine the local region among the object regions according to a user input and/or determine the local region among the object regions based on its ability developed through previous training. For example, the user input and/or the ability developed through previous training may determine, as the local region, a main object region including a main object among the object regions. The neural local encoder 420 may, based on the input image 401, the style information 402, and the region information 421, generate the local feature representation 422.

The neural local encoder 420 may include the region segmentation module 310 of FIG. 3. In this example, the neural local encoder 420 may generate the region information 421 of the input image 401 using the region segmentation module 310 and generate, based on the input image 401, the style information 402, and the region information 421, the local feature representation 422.

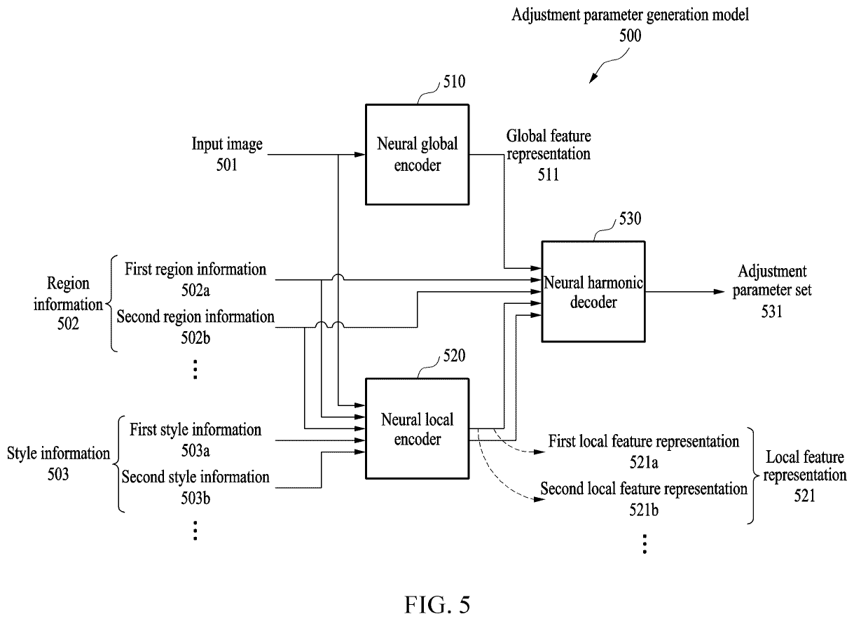

FIG. 5 illustrates an example of an operation of a multi-region-based adjustment parameter generation model (e.g., an adjustment parameter generation model 500). Referring to FIG. 5, region information 502 may include first region information 502a about a first local region and second region information 502b about a second local region. Style information 503 may include first style information 503a to be applied to the first local region and second style information 503b to be applied to the second local region. A local feature representation 521 may include a first local feature representation 521a corresponding to the first style information 503a of the first region information 502a and a second local feature representation 521b corresponding to the second style information 503b of the second region information 502b. FIG. 5 illustrates two sub-items for each of the region information 502, the style information 503, and the local feature representation 521. However, examples are not limited thereto. For example, each of the region information 502, the style information 503, and the local feature representation 521 may include n sub-items.

A neural global encoder 510 may, based on an input image 501, generate a global feature representation 511. The global feature representation 511 may be generated by inputting the input image 501 into the neural global encoder 510.

A neural local encoder 520 may, based on the input image 501, the first region information 502a, the second region information 502b, the first style information 503a, and the second style information 503b, generate a first local feature representation 521a and a second local feature representation 521b. The first local feature representation 521a and the second local feature representation 521b may be generated by inputting the input image 501, the first region information 502a, the second region information 503b, the first style information 503a, and the second style information 503b into the neural local encoder 520.

The first region information 502a, the second region information 502b, the first style information 503a, and the second style information 503b may be input into the neural local encoder 520 sequentially or in parallel. When sequential input into the neural local encoder 520 is conducted, the input image 501, the first region information 502a, and the first style information 503a may be input into the neural local encoder 520. The neural local encoder 520 may generate the first local feature representation 521a. Then, the input image 501, the second region information 502b, and the second style information 503b may be input into the neural local encoder 520. The neural local encoder 520 may generate the second local feature representation 521b.

Alternatively, neural local encoders that share network parameters with the neural local encoder 520 may exist. A first neural local encoder of the neural local encoders may, based on the input image 501, the first region information 502a, and the first style information 503a, generate the first local feature representation 521a. A second neural local encoder may generate, based on the input image 501, the second region information 502b, and the second style information 503b, a second local feature representation 521b. The generation of the first local feature representation 521a by the first neural local encoder and the generation of the second local feature representation 521b by the second neural local encoder may be conducted simultaneously.

When parallel input into the neural local encoder 520 is conducted, the input image 501, the first region information 502a, the second region information 502b, the first style information 503a, and the second style information 503b may be simultaneously input into the neural local encoder 520. The neural local encoder 520 may generate the first local feature representation 521a and the second local feature representation 521b simultaneously.

A neural harmonic decoder 530 may, based on the first local feature representation 521a, the second local feature representation 521b, the global feature representation 511, the first region information 502a, and the second region information 502b, generate an adjustment parameter set 531. The adjustment parameter set 531 may be generated by inputting the first local feature representation 521a, the second local feature representation 521b, the global feature representation 511, the first region information 502a, and the second region information 502b into the neural harmonic decoder 530.

The neural harmonic decoder 530 may, based on the harmony of the first local feature representation 521a, the second local feature representation 521b, and the global feature representation 511, determine the adjustment parameter set 531. The input image 501 may include different main objects. The local regions may correspond to different main objects. The first region information 502a of the first local region and the second region information 502b of the second local region may correspond to region masks that filter different regions. The first style information 503a and the second style information 503b may correspond to different styles. The neural harmonic decoder 530 may generate the adjustment parameter set 531 such that the local regions of different styles and a background region may be adjusted harmoniously.

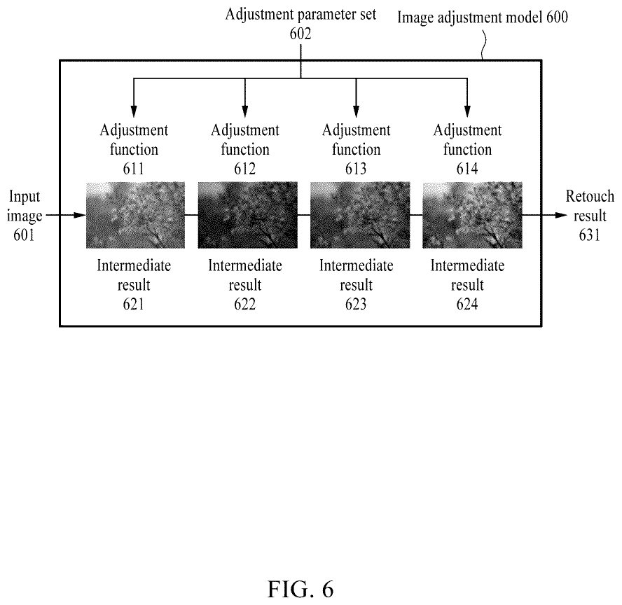

FIG. 6 illustrates an example of an operation of an image adjustment model. Referring to FIG. 6, an image adjustment model 600 (e.g., the image adjustment model 120 of FIG. 1) may generate a retouch result 631 by adjusting an input image 601 using an adjustment parameter set 602. The input image 601 may be preprocessed before the adjustment parameter set 602 is used. For example, the preprocessing of the input image 601 may include demosaicking.

The image adjustment model 600 may adjust the input image 601 using adjustment functions 611 to 614. The adjustment functions 611 to 614 may include at least some of a first adjustment function for adjusting a digital gain, a second adjustment function for adjusting white balance, a third adjustment function for performing color correction, a fourth adjustment function for performing gamma correction, a fifth adjustment function for performing tone mapping, a sixth adjustment function for performing denoising, and/or a seventh adjustment function for performing deblurring. The adjustment parameter set 602 may include input values of the adjustment functions 611 to 614. The adjustment parameter set 602 may include a parameter for adjusting at least some of a digital gain, white balance, color correction, gamma correction, tone mapping, denoising, and/or deblurring. The image adjustment model 600 may correspond to an ISP pipeline. In an example, the image adjustment model 600 may generate an intermediate result 621 by applying the adjustment function 611 to the input image 601 (or the preprocessed input image 601), an intermediate result 622 by applying the adjustment function 612 to the intermediate result 621, an intermediate result 623 by applying the adjustment function 613 to the intermediate result 622, and an intermediate result 624 by applying the adjustment function 614 to the intermediate result 623. In one or more examples, the retouch result 631 may correspond to the intermediate result 624 or the retouch result 631 may be generated by postprocessing the intermediate result 624.

An adjustment parameter generation model (e.g., the adjustment parameter generation model 110 of FIG. 1) may, based on style information, determine parameters of the adjustment parameter set 602. The image adjustment model 600 may generate intermediate results 621 to 624 by inputting the parameters of the adjustment parameter set 602 into the adjustment functions 611 to 614 and may output a retouch result 631. For example, the adjustment function 611 may correspond to a combination of the first adjustment function and the second adjustment function, the adjustment function 612 may correspond to the third adjustment function, the adjustment function 613 may correspond to the sixth adjustment function, and the adjustment function 614 may correspond to the fifth adjustment function.

At least a portion of the image adjustment model 600 may be implemented as a hardware module. For example, at least a portion of the ISP pipeline of the image adjustment model 600 may include a hardware module. The parameters of the adjustment parameter set 602 may be input into the hardware module of the ISP pipeline. The retouch result 631 may be obtained quickly by accelerating the hardware module.

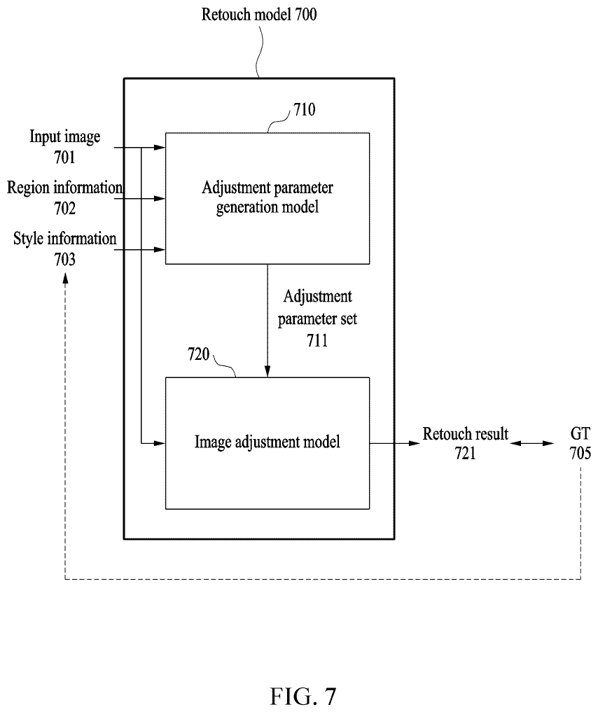

FIG. 7 illustrates an example of a process of training an adjustment parameter generation model and/or an image adjustment model. Referring to FIG. 7, a retouch model 700 (e.g., the retouch model 100 of FIG. 1) may include an adjustment parameter generation model 710 (e.g., the adjustment parameter generation model 110 of FIG. 1) and an image adjustment model 720 (e.g., the image adjustment model 120 of FIG. 1). The adjustment parameter generation model 710 and/or the image adjustment model 720 may include a neural network. The neural network may be trained during a training process.

The adjustment parameter generation model 710 may generate an adjustment parameter set 711, based on an input image 701, region information 702, and style information 703. The image adjustment model 720 may generate a retouch result 721 by adjusting the input image 701 based on the adjustment parameter set 711. The retouch result 721 may be compared to GT 705. The adjustment parameter generation model 710 and/or the image adjustment model 720 may be trained such that the difference between the retouch result 721 and the GT 705 decreases.

The GT 705 may correspond to a target retouch image of a target style. The style information 703 may be determined based on the GT 705. The style information 703 may include a target style image and/or a target style vector. The target style image may correspond to a target retouch result of the GT 705. The target style vector may be a vector generated from the target retouch result.

The target retouch image of the GT 705 may have the target style throughout the entire image. During the training process, the style information 703 may not be provided to a neural global encoder of the adjustment parameter generation model 710 and may be provided to a neural local encoder of the adjustment parameter generation model 710. Based on a global feature representation and a local feature representation generated in this state, the neural global encoder, the neural local encoder, and the neural harmonic decoder may be trained. According to this training approach, the neural harmonic decoder may generate the adjustment parameter set 711 for applying the target style to the local region and harmoniously representing the local region and another region.

The training process of FIG. 7 may similarly apply to a multi-region technique in which the region information 702, the style information 703, and the local feature representation include sub-items. For example, the adjustment parameter set 711 may be generated based on the region information 702 and the style information 703, each including sub-items. The adjustment parameter generation model 710 and/or the image adjustment model 720 may be trained such that the difference between the retouch result 721 and the GT 705 decreases. According to this training technique, the neural harmonic decoder may generate the adjustment parameter set 711 that allows local regions of different styles and a background region to be adjusted harmoniously.

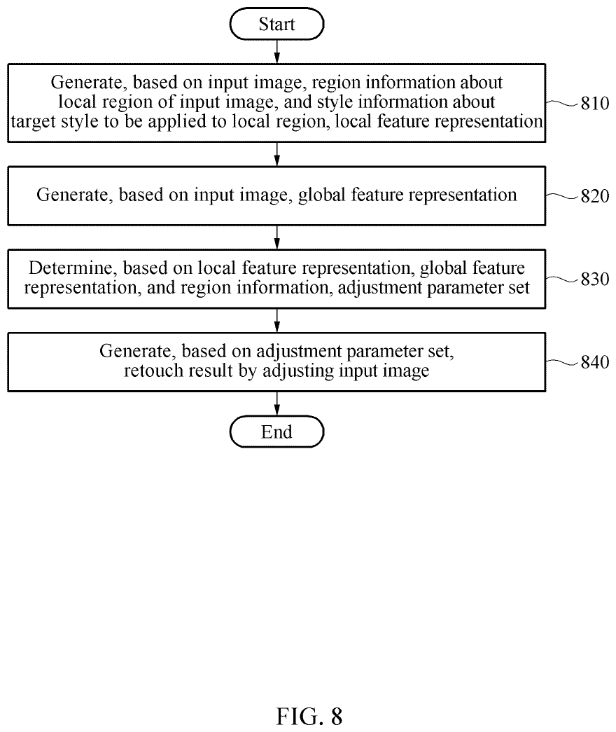

FIG. 8 illustrates an example of an image enhancement method. Operations 810 to 840 described below may be performed in the order and manner as shown and described below with reference to FIG. 8, but the order of one or more of the operations may be changed, one or more of the operations may be omitted, and/or two or more of the operations may be performed in parallel or simultaneously without departing from the spirit and scope of the example embodiments described herein.

Referring to FIG. 8, in operation 810, an electronic device may, based on an input image, region information about a local region of the input image, and style information about a target style to be applied to the local region, generate a local feature representation. In operation 820, the electronic device may generate a global feature representation based on the input image. In operation 830, the electronic device may, based on the local feature representation, the global feature representation, and the region information, determine an adjustment parameter set. In operation 840, the electronic device may, based on the adjustment parameter set, generate a retouch result by adjusting the input image.

The local feature representation may be generated by inputting the input image, the region information, and the style information into a neural local encoder. The global feature representation may be generated by inputting the input image into a neural global encoder.

The adjustment parameter set may be generated by inputting the local feature representation, the global feature representation, and the region information into a neural harmonic decoder.

The neural harmonic decoder may, based on the harmony between the local feature representation and the global feature representation, determine the adjustment parameter set.

The region information may include first region information about a first local region and second region information about a second local region. The style information may include first style information to be applied to the first local region and second style information to be applied to the second local region.

Operation 810 may include an operation of generating, based on the first region information, the second region information, the first style information, and the second style information, a first local feature representation corresponding to the first region information and the first style information and a second local feature representation corresponding to the second region information and the second style information.

Operation 830 may include an operation of determining, based on the first local feature representation, the second local feature representation, the global feature representation, the first region information, and the second region information, an adjustment parameter set.

The electronic device may, based on semantic segmentation, determine the local region from the input image. The electronic device may, based on the input image, generate a region mask corresponding to the region information.

The style information may include a target style image of a target style, a target style vector of the target style, or a combination thereof.

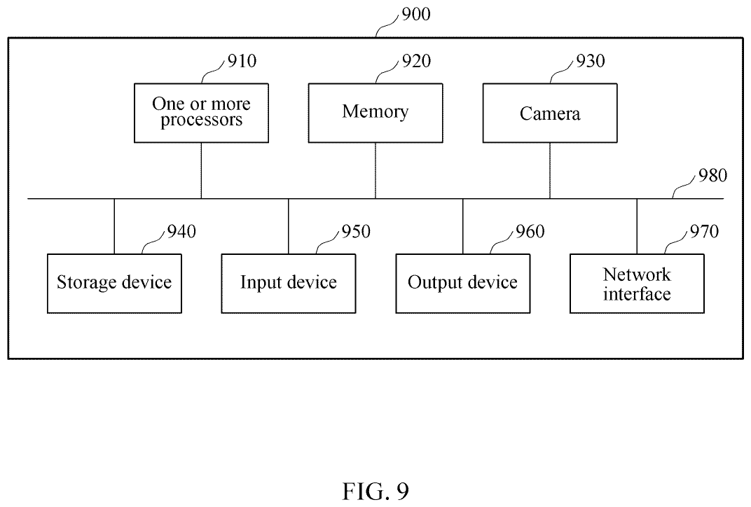

FIG. 9 illustrates an example of a configuration of an electronic device. Referring to FIG. 9, an electronic device 900 may include one or more processors 910, a memory 920, a camera 930, a storage device 940, an input device 950, an output device 960, and a network interface 970. These components may communicate with one another via a communication bus 980. For example, the electronic device 900 may be implemented as at least some of a mobile device, such as a mobile phone, a smartphone, a personal digital assistant (PDA), a netbook, a tablet computer, a laptop computer, and the like, a wearable device, such as a smartwatch, a smart band, smart glasses, and the like, a home appliance, such as a television (TV), a smart TV, a refrigerator, and the like, a security device, such as a door lock and the like, and a vehicle such as an autonomous vehicle, a smart vehicle, and the like.

The one or more processors 910 may execute instructions or functions to be executed in the electronic device 900. For example, the one or more processors 910 may process the instructions stored in the memory 920 or the storage device 940. The one or more processors 910 may perform the one or more operations described with reference to FIGS. 1 to 8. For example, the one or more processors may include (and/or implement any one, any combination, or all of operations of) the retouch model 100, the adjustment parameter generation model 200, the region segmentation module 310, and/or the adjustment parameter generation model 500 described above, as non-limiting examples. The memory 920 may include a non-transitory computer-readable storage medium or a non-transitory computer-readable storage device. The memory 920 may store instructions to be executed by the one or more processors 910 and may store related information while software and/or an application is being executed by the electronic device 900. For example, the memory 920 may include non-transitory computer-readable storage medium storing instructions that, when executed by the one or more processors 910, configure the one or more processors 910 to perform any one, any combination, or all of operations and/or methods disclosed herein with reference to FIGS. 1-8.

The camera 930 may generate an input image. The input image may include a photo and/or a video. The storage device 940 may include a non-transitory computer-readable storage medium or a non-transitory computer-readable storage device. The storage device 940 may store a greater amount of information than the memory 920 and store the information for a long period of time. For example, the storage device 940 may include magnetic hard disks, optical disks, flash memory, floppy disks, or other forms of non-volatile memory known in the art.

The input device 950 may receive an input from a user through a traditional input scheme using a keyboard and a mouse and through a new input scheme such as a touch input, a voice input, and an image input. For example, the input device 950 may detect an input from a keyboard, a mouse, a touchscreen, a microphone or a user and may include any other device configured to transfer the detected input to the electronic device 900. The output device 960 may provide a user with an output of the electronic device 900 through a visual channel, an auditory channel, or a tactile channel. The output device 960 may include, for example, a display, a touchscreen, a speaker, a vibration generator, or any other device configured to provide a user with the output. The network interface 970 may communicate with an external device via a wired or wireless network.

The electronic devices, one or more processors, memories, cameras, storage devices, input devices, output devices, network interfaces, electronic device 900, one or more processors 910, memory 920, camera 930, storage device 940, input device 950, output device 960, and network interface 970, and network interface 970 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with image enhancement, the method comprising:
based on an input image, region information about a local region of the input image, and style information about a target style to be applied to the local region, generating a local feature representation;
generating a global feature representation based on the input image;
based on the local feature representation, the global feature representation, and the region information, determining an adjustment parameter set; and
based on the adjustment parameter set, generating a retouch result by adjusting the input image.

2. The method of claim 1, wherein
the local feature representation is generated by inputting the input image, the region information, and the style information into a neural local encoder, and
the global feature representation is generated by inputting the input image into a neural global encoder.

3. The method of claim 1, wherein the adjustment parameter set is generated by inputting the local feature representation, the global feature representation, and the region information into a neural harmonic decoder.

4. The method of claim 3, wherein the neural harmonic decoder is configured to, based on harmony between the local feature representation and the global feature representation, determine the adjustment parameter set.

5. The method of claim 1, wherein
the region information comprises first region information about a first local region and second region information about a second local region, and
the style information comprises first style information to be applied to the first local region and second style information to be applied to the second local region.

6. The method of claim 5, wherein the generating of the local feature representation comprises, based on the input image, the first region information, the second region information, the first style information, and the second style information, generating a first local feature representation corresponding to the first region information and the first style information and a second local feature representation corresponding to the second region information and the second style information.

7. The method of claim 6, wherein the determining of the adjustment parameter set comprises, based on the first local feature representation, the second local feature representation, the global feature representation, the first region information, and the second region information, determining the adjustment parameter set.

8. The method of claim 1, further comprising, based on semantic segmentation, determining the local region from the input image.

9. The method of claim 1, further comprising, based on the input image, generating a region mask corresponding to the region information.

10. The method of claim 1, wherein the style information comprises either one or both of a target style image of the target style and a target style vector of the target style.

11. A non-transitory computer-readable storage medium storing instructions that, when executed by one or more processors, configure the one or more processors to perform the method of claim 1.

12. An electronic device comprising:
one or more processors configured to:
based on an input image, region information about a local region of the input image, and style information about a target style to be applied to the local region, generate a local feature representation;
based on the input image, generate a global feature representation;
based on the local feature representation, the global feature representation, and the region information, determine an adjustment parameter set; and
based on the adjustment parameter set, generate a retouch result by adjusting the input image.

13. The electronic device of claim 12, wherein
the local feature representation is generated by inputting the input image, the region information, and the style information into a neural local encoder, and
the global feature representation is generated by inputting the input image into a neural global encoder.

14. The electronic device of claim 12, wherein the adjustment parameter set is generated by inputting the local feature representation, the global feature representation, and the region information into a neural harmonic decoder.

15. The electronic device of claim 14, wherein the neural harmonic decoder is configured to, based on harmony between the local feature representation and the global feature representation, determine the adjustment parameter set.

16. The electronic device of claim 12, wherein
the region information comprises first region information about a first local region and second region information about a second local region, and
the style information comprises first style information to be applied to the first local region and second style information to be applied to the second local region.

17. The electronic device of claim 16, wherein, for the generating of the local feature representation, the one or more processors are configured to, based on the input image, the first region information, the second region information, the first style information, and the second style information, generate a first local feature representation corresponding to the first region information and the first style information and a second local feature representation corresponding to the second region information and the second style information.

18. The electronic device of claim 17, wherein, for the determining of the adjustment parameter set, the one or more processors are configured to, based on the first local feature representation, the second local feature representation, the global feature representation, the first region information, and the second region information, determine the adjustment parameter set.

19. The electronic device of claim 12, wherein the one or more processors are configured to, based on the input image, generate a region mask corresponding to the region information.

20. The electronic device of claim 12, wherein the style information comprises either one or both of a target style image of the target style and a target style vector of the target style.
